(19) United States
(12) Patent Application Publication
(10) Pub. No.: US 2024/0333149 A1
(43) Pub. Date: Oct. 3, 2024

(54) MULTI-LEVEL CONVERTER

(71) Applicant: Nanjing Silergy Micro Technology Co., Ltd., Nanjing (CN)

(72) Inventors: Siyuan Chen, Nanjing (CN); Sihua Wen, Nanjing (CN); Yu Wu, Nanjing (CN)

(21) Appl. No.: 18/617,915

(22) Filed: Mar. 27, 2024

(30) Foreign Application Priority Data
Mar. 29, 2023 (CN) 202310332364.9

(51) Int. Cl. H02M 3/07; H02M 1/00; H02M 1/32; H02M 3/158

(52) U.S. Cl. CPC H02M 3/07; H02M 1/0095; H02M 1/32; H02M 3/158

(57) ABSTRACT

A multi-level converter can include: a switch capacitor circuit having M flying capacitors and 2*(M+1) transistors, where M is a positive integer; an inductive element; a balance circuit coupled to a common node of the switch capacitor circuit and the inductive element; and where the balance sub-circuit includes at least one balance sub-circuit, a balance switch, and a balance capacitor, and where the flying capacitor and the balance capacitor are coupled to each other in one of series and parallel connections by controlling the balance switch to selectively to be turned on and off.

### RELATED APPLICATIONS

This application claims the benefit of Chinese Patent Application No. 202310332364.9, filed on Mar. 29, 2023, which is incorporated herein by reference in its entirety.

### FIELD OF THE INVENTION

The present invention generally relates to the field of power electronics, and more particularly to multi-level converters.

### BACKGROUND

A switched-mode power supply (SMPS), or a “switching” power supply, can include a power stage circuit and a control circuit. When there is an input voltage, the control circuit can consider internal parameters and external load changes, and may regulate the on/off times of the switch system in the power stage circuit. Switching power supplies have a wide variety of applications in modern electronics. For example, switching power supplies can be used to drive light-emitting diode (LED) loads.

### BRIEF DESCRIPTION OF THE DRAWINGS

FIG. 1 is a schematic block diagram of an example three-level DC-DC converter.

FIG. 2 is a schematic block diagram of a first example multi-level converter, in accordance with embodiments of the present invention.

FIG. 3 is a waveform diagram of a first example operation of the three-level converter when a duty cycle is relatively small, in accordance with embodiments of the present invention.

FIG. 4 is a waveform diagram of a second example operation of the three-level converter when a duty cycle is relatively large, in accordance with embodiments of the present invention.

FIG. 5 is a schematic block diagram of a second example multi-level converter, in accordance with embodiments of the present invention.

FIG. 6 is a waveform diagram of a first example operation of the second multi-level converter, in accordance with embodiments of the present invention.

FIG. 7 is a waveform diagram of a second example operation of the second three-level converter, in accordance with embodiments of the present invention.

FIG. 8 is a schematic block diagram of a third example multi-level converter, in accordance with embodiments of the present invention.

FIG. 9 is a schematic block diagram of a fourth example multi-level converter, in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

Existing multi-level capacitor technology scheme are widely used because they can greatly reduce the volt-second product on the inductor, thereby reducing the volume of the inductor. However, the voltage balance of the capacitor in the multi-level capacitor technology scheme has a large influence on system performance. If the voltage balance of the capacitor is not good, the stress of a transistor (e.g., MOS) in the multi-level capacitor technology scheme can be increased, which can lead to damage and failure of the share. Therefore, a more complex active control strategy may be needed to adjust the voltage balance of the capacitor.

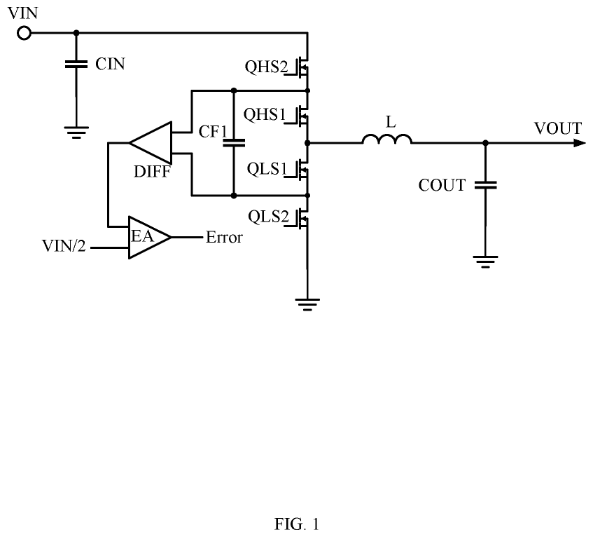

Referring now to FIG. 1, shown is a schematic block diagram of an example three-level buck converter. In this example, the voltage of flying capacitor CF1 can be detected by differential amplifier DIFF, and the output signal of differential amplifier DIFF can connect to an input terminal of error amplifier EA, which may be compared against half of the input voltage (VIN/2) to generate error signal ‘Error’. Error signal ‘Error’ can control the phase relationship or duty cycle difference between transistors QHS1 and QHS2, in order to adjust the amount of charge charged into and discharged from flying capacitor CF1, and to control the voltage of flying capacitor CF1 to be equal to half of the input voltage (VIN/2). This method has advantages of relatively high efficiency and low heating, but may also have problems of complex control, the voltage balance being easily affected by a load current, and poor balance effect under a dynamic duty cycle.

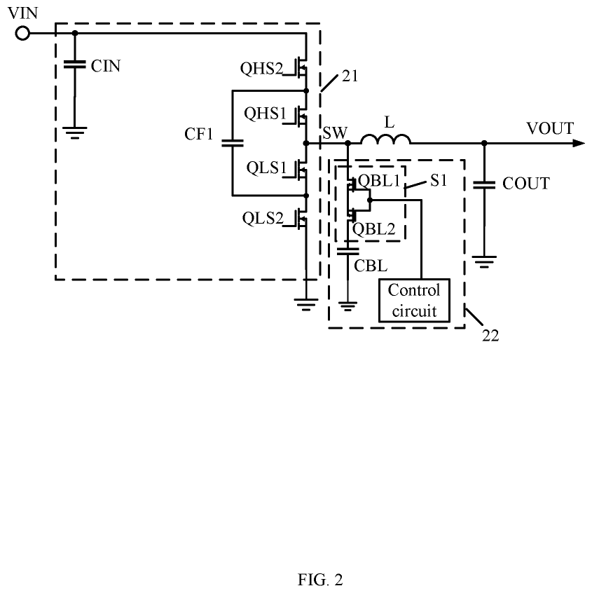

Referring now to FIG. 2, shown is a schematic block diagram of a first example multi-level converter, in accordance with embodiments of the present invention. In this particular example, the multi-level capacitor converter (e.g., a three-level converter) can include switch capacitor circuit 21, balance circuit 22, and inductive element L. Switch capacitor circuit 21 can perform DC conversion for input voltage VIN, and may include filter capacitor CIN, flying capacitor CF1, and four transistors QHS2, QHS1, QLS1, and QLS2. Filter capacitor CIN can connect to an input terminal of the multi-level converter to receive input voltage VIN. Transistors QHS2, QHS1, QLS1, and QLS2 can connect in series between input voltage VIN and a ground terminal of the three-level buck converter. One terminal of flying capacitor CF1 can connect to the common node of transistors QHS2 and QHS1, and the other terminal of flying capacitor CF1 can connect to the common node of transistors QLS1 and QLS2. Balance circuit 22 can include balance switch S1 and balance capacitor CBL. Balance switch S1 may be controlled to selectively turn on and off, such that flying capacitor CF1 and balance capacitor CBL are selectively connected in series or in parallel. In this way, in different operating stages of an operating cycle, a proportional relationship between the voltage on balance capacitor CBL and the voltage on flying capacitor CF1, and a proportional relationship between the voltage on balance capacitor CBL, the voltage on flying capacitor CF1, and input voltage VIN or output voltage VOUT, can be generated, in order to achieve balanced control of the flying capacitor.

Balance circuit 22 can connect between common node SW and the ground terminal. Here common node SW may be coupled with the output terminal or input terminal of the multi-level converter through the inductive element. In this example, the multi-level capacitor converter is a three-level buck converter, and common node SW can be coupled to the output terminal through inductive L. In addition, transistors QHS1 and QHS2 connected in series between the input terminal of the multi-level converter and common node SW can be configured as upper transistors, and transistors QLS1 and QLS2 connected in series between common node SW and the ground terminal can be configured as lower transistors.

In particular embodiments, balance circuit 22 can include a balance sub-circuit including balance switch S1 and balance capacitor CBL connected in series. For example, balance switch S1 can be a bidirectional current blocking transistor. The bidirectional current blocking transistor structure can include transistors QBL1 and QBL2 connected in series. When balance switch S1 is turned off, no current may be allowed to flow from common node SW to balance capacitor CBL, and no current allowed to flow from balance capacitor CBL to common node SW. Balance circuit 22 can also include a control circuit, which can control balance switch S1 to turn on when a voltage at common node SW is not equal to input voltage VIN or a zero voltage.

In particular embodiments, because the three-level converter has only one flying capacitor, balance circuit 22 may include one balance sub-circuit including balance switch S1 and balance capacitor CBL connected in series. In other examples, the multi-level capacitor converter can include M flying capacitors and 2*(M+1) transistors, and balance circuit 22 can include M balance sub-circuits, each of the M balance sub-circuits including a balance switch and a balance capacitor connected in series. Here, M is a positive integer. Further, in the three-level converter, when the voltage on common node SW is equal to input voltage VIN or zero voltage, balance switch S1 can be turned off. That is, when all the upper transistors are turned on or no upper transistor is turned on, balance switch S1 can be turned off. When balance switch S1 is turned off, balance circuit 22 can essentially be disconnected from common node SW. When balance switch S1 is turned on, balance capacitor CBL can effectively connect to common node SW.

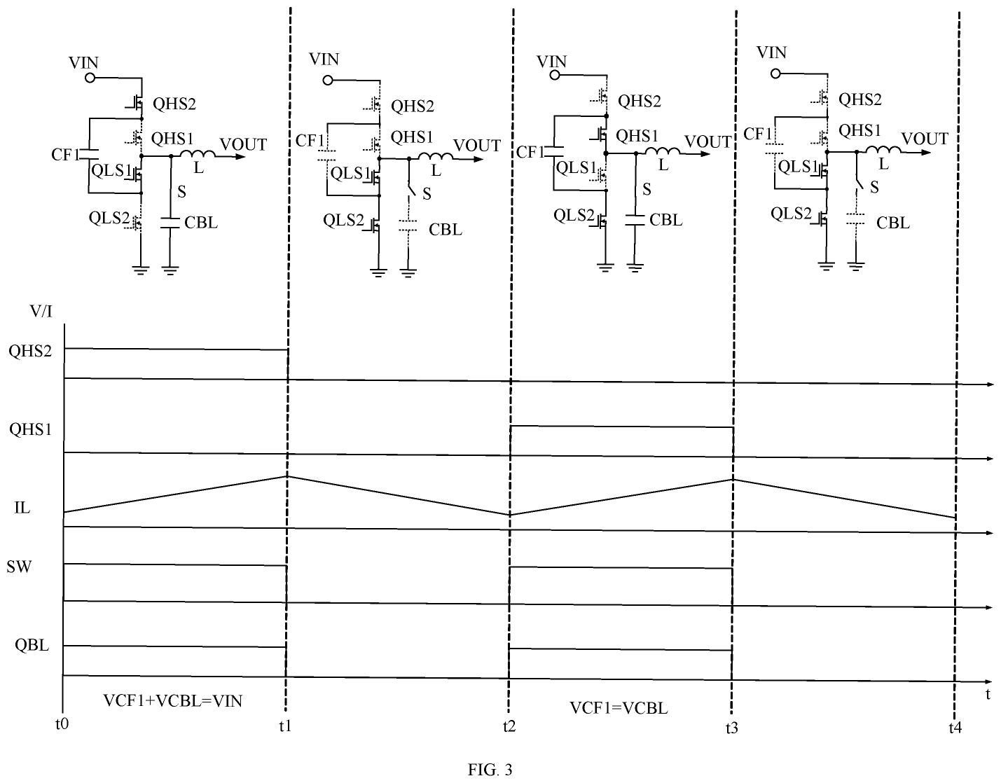

Referring now to FIG. 3, shown is a waveform diagram of a first example operation of the three-level converter when a duty cycle is relatively small, in accordance with embodiments of the present invention. Viewed in combination with the circuit (see, e.g., FIG. 2) and waveform diagrams can facilitate explanation of the voltage balance principle and operation process of the example three-level converter. Here for example, transistors QHS1 and QLS1 can be turned on complementary, and transistors QHS2 and QLS2 may be turned on complementary, in order to illustrate the operation principle and process. Each operation cycle of the three-level converter can include four stages, and the capacity of flying capacitor CF1 can be assumed as large enough so that the voltage of flying capacitor CF1 does not change significantly during the charging and discharging phase. When the duty cycle is less than 50%, that is, output voltage VOUT is less than half of input voltage VIN (VOUT<0.5 VIN), the operation process is as follows.

In first stage t0-t1, transistor QHS2 can be turned on, transistor QHS1 turned off, flying capacitor CF1 may be charged, and inductor current IL can rise. Balance switch S1 can be turned on, and balance capacitor CBL can connect in series with flying capacitor CF1. In the case of ignoring the on-resistance, the sum of voltage VCBL on balance capacitor CBL and voltage VCF1 on flying capacitor CF1 may be equal to input voltage VIN (VCBL+VCF1=VIN).

In second stage t1-t2, transistor QHS1 can be turned off, transistor QHS2 turned off, flying capacitor CF1 may be open circuited, and inductor current IL can decrease. Balance switch S1 can be turned off, and balance capacitor CBL may be open circuited. At this time, the voltage on flying capacitor CF1 and the voltage on balance capacitor CBL may remain unchanged.

In third stage t2-t3, transistor QHS1 can be turned on, transistor QHS2 turned off, flying capacitor CF1 may be discharged, and inductor current IL can rise. Balance switch S1 may be turned on, and balance capacitor CBL can effectively be connected in parallel with flying capacitor CF1. In the case of ignoring the on-resistance, voltage VCBL on balance capacitor CBL can be equal to voltage VCF1 on flying capacitor CF1 (VCBL=VCF1).

In fourth stage t3-t4, transistor QHS1 can be turned off, transistor QHS2 turned off, flying capacitor CF1 may be open circuited, and inductor current IL can drop. Balance switch S1 can be turned off, and balance capacitor CBL may be open circuited. At this time, the voltage on flying capacitor CF1 and the voltage on balance capacitor CBL may remain unchanged.

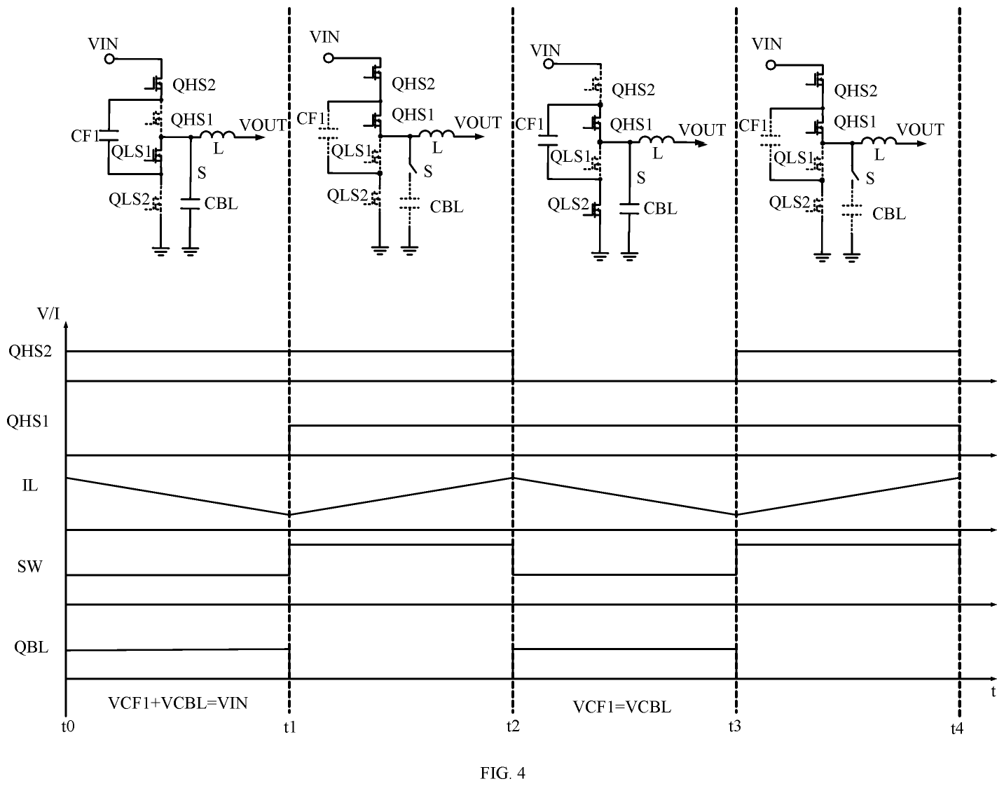

Referring now to FIG. 4, shown is a waveform diagram of a second example operation of the three-level converter when a duty cycle is relatively large, in accordance with embodiments of the present invention. When the duty cycle is not less than 50%; that is, output voltage VOUT may not be less than half of input voltage VIN (VOUT>0.5 VIN), and the operation process is as follows. In first stage t0-t1, transistor QHS1 can be turned off, transistor QHS2 turned on, flying capacitor CF1 can be charged, and inductor current IL may decrease. Balance switch S1 can be turned on, and balance capacitor CBL may essentially be connected in series with flying capacitor CF1. Ignoring the on-resistance, the sum of voltage VCBL on balance capacitor CBL and voltage VCF1 on flying capacitor CF1 may be equal to input voltage VIN (VCBL+VCF1=VIN).

In second stage t1-t2, transistor QHS1 may be turned on, transistor QHS2 turned on, flying capacitor CF1 can be open circuited, and inductor current IL may increase. Balance switch S1 can be turned off, and balanced capacitor CBL may be open circuited. At this time, the voltages on flying capacitor CF1 and balance capacitor CBL may remain unchanged.

In third stage t2-t3, transistor QHS1 may be turned on, transistor QHS2 turned off, flying capacitor CF1 discharged, and inductor current IL may decrease. Balance switch S1 can be turned on, and balanced capacitor CBL may essentially be connected in parallel with flying capacitor CF1. Ignoring the on-resistance, voltage VCBL on balance capacitor CBL can be equal to voltage VCF1 on flying capacitor CF1 (VCBL=VCF1).

In fourth stage t3-t4, transistor QHS1 can be turned on, transistor QHS2 turned on, flying capacitor CF1 may be open circuited, and inductor current IL can increase. Balance switch S1 may be turned off, and balance capacitor CBL can be open circuited. At this time, the voltages on flying capacitor CF1 and balance capacitor CBL may remain unchanged.

According to the above operation process, no matter whether the duty cycle is greater than 50%, the capacitor voltage relationship in the first stage can be that the sum of voltage VCBL on balance capacitor CBL and voltage VCF1 on flying capacitor CF1 is equal to input voltage VIN (VCBL+VCF1=VIN), and in the third stage can be that voltage VCBL on balance capacitor CBL is equal to voltage VCF1 on flying capacitor CF1 (VCBL=VCF1), respectively. When ignoring the on-resistance and capacitor voltage ripple, voltages VCF1 and VCBL on flying capacitors CF1 and CF1 can be equal to half of input voltage VIN (VIN=2*VCF1=2*VCBL). This realizes voltage balance of the flying capacitor, the voltage on the flying capacitor can remain at a target voltage, and the target voltage may be half of input voltage VIN (½VIN).

In addition, when voltage VSW on common node SW is equal to input voltage VIN (VSW=VIN), balance switch S1 can be turned off. Also, when voltage VSW on common node SW is equal to half of input voltage VIN (VSW=½VIN), balance S1 may be turned on. Therefore, the balance circuit in the three-level converter can control flying capacitor CF1 and balance capacitor CBL to be selectively connected in series or parallel by selectively controlling the balance switch to be turned on and off. In this way, in different operation stages of an operation cycle, a proportional relationship between the voltage on balance capacitor CBL and the voltage on flying capacitor CF1 can be generated, and a proportional relationship between the voltage on balance capacitor CBL, the voltage on flying capacitor CF1, and input voltage VIN or output voltage VOUT, can be generated. Thus, balance control of the flying capacitor may be realized, as well as multi-level converter lossless balance. As compared with the traditional balance approach, this method may have advantages of simple control, high balance accuracy, good robustness, and wide adaptability.

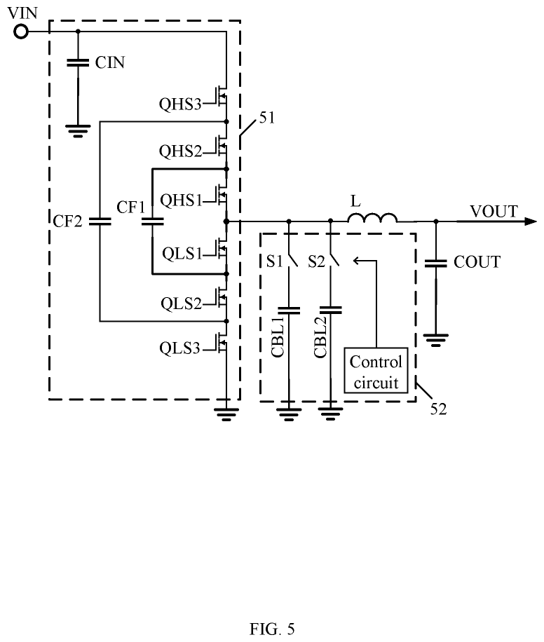

Referring now to FIG. 5, shown is a schematic block diagram of a second example multi-level converter, in accordance with embodiments of the present invention. This particular example multi-level converter (e.g., a four-level converter) can include switch capacitor circuit 51, balance circuit 52, and inductive element L. Switched capacitor circuit 51 can perform DC conversion for input voltage VIN, and may include two flying capacitors CF1 and CF2. That is, M=2, and six transistors QHS3, QHS2, QHS1, QLS1, QLS2, and QLS3 can connect between input voltage VIN and the ground terminal. One terminal of transistor QHS1 can connect to one terminal of transistor QLS1 through flying capacitor CF1, and one terminal of transistor QHS2 can connect to one terminal of transistor QLS2 through flying capacitor CF2. Switch capacitor circuit 51 can also include filter capacitor CIN, which can connect to the input terminal of the four-level converter.

Balance circuit 52 can change the series-parallel relationship between the flying capacitor and the balance capacitor in the balance circuit in different operation stages of an operation cycle, in order to achieve balance control of the flying capacitor. Balance circuit 52 can connect between common node SW and the ground terminal. In addition, transistors QHS3, QHS2, and QHS1 connected in series between input terminal of the multi-level converter and common node SW may be configured as upper transistors, while transistors QLS3, QLS2, and QLS1 connected in series between common node SW and the ground terminal may be configured as lower transistors.

In particular embodiments, balance circuit 52 can include two balance sub-circuits. The first balance sub-circuit can include balance switch S1 and balance capacitor CBL1 connected in series, and the second balance sub-circuit can include balance switch S2 and balance capacitor CBL2. Further, one terminal of the balance switch in each balance sub-circuit can connect to common node SW, the other terminal of the balance switch can connect to the balance capacitor, and the other terminal of the balance circuit can connect to the ground terminal.

In particular embodiments, when the balance switch in one balance sub-circuit is turned on, the balance capacitor can be coupled to at least one flying capacitor, and only one balance switch in the balance sub-circuit may be turned on at the same time period. Balance circuit 52 can also include a control circuit. The control circuit can control the balance switch in the corresponding balance sub-circuit to be turned on when the voltage of common node SW is not either of input voltage VIN and zero voltage, such that the corresponding balance capacitor can connect to common node SW. Further, when the voltage of common node SW is equal to input voltage VIN of the multi-level converter or zero voltage, all balance switches may be turned off. That is, when all the upper transistors are turned on or none of the upper transistors is turned on, all balance switches can be turned off. When all balance switches are turned off, balance circuit 52 may essentially be disconnected from common node SW.

Furthermore, the steady voltages of the balance capacitors of the two balance sub-circuits in balance circuit 52 can be different. Here for example, the steady voltage of balance capacitor CBL1 in the first balance sub-circuit is ⅓*VIN, and the stable voltage of balance capacitor CBL2 in the second balance sub-circuit is ⅔*VIN. In addition, when the voltage of common node SW is ⅓*VIN, balance switch S1 in the first balance sub-circuit can be turned on to connect balance capacitor CBL1 to common node SW. When the voltage of common node SW is ⅔*VIN, balance switch S2 in the second balance sub-circuit can be turned on to connect balance capacitor CBL2 to common node SW. That is, when one upper transistor is turned on, balance switch S1 in the first balance sub-circuit is turned on, and when two upper transistors are turned on, balance switch S2 in the second balance sub-circuit may be turned on.

In particular embodiments, balance circuit 52 can control balance switch S1 in the first balance sub-circuit to connect balance capacitor CBL1 to common node SW, or to control balance switch S2 in the second balance sub-circuit to connect balance capacitor CBL2 to common node SW, by monitoring that the number of the upper transistors in switch capacitor circuit 51 turned on is 1 or 2.

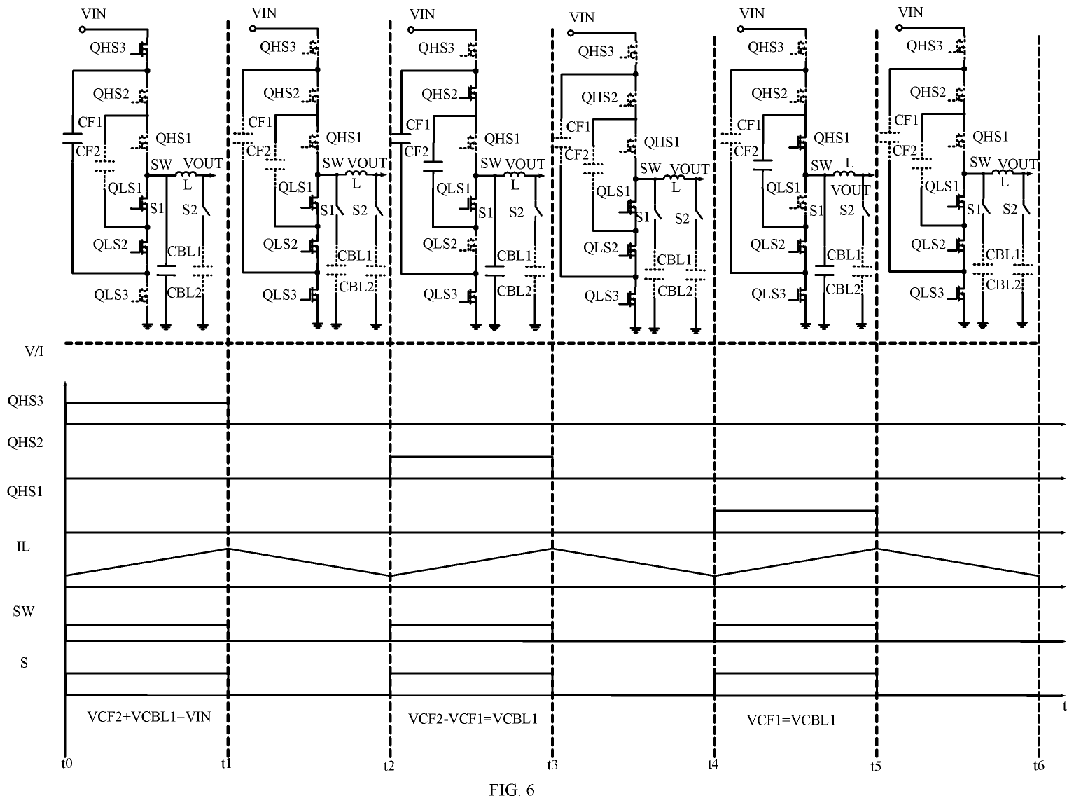

Referring now to FIG. 6, shown is a waveform diagram of a first example operation of the second multi-level converter, in accordance with embodiments of the present invention. The following is combined with the circuit (see, e.g., FIG. 5) and waveform diagrams to explain the voltage balance principle and operation process of the three-level converter. Here for example, transistors QHS1 and QLS1 can be turned on in complementary fashion, transistors QHS2 and QLS2 may be turned on in complementary fashion, and transistor QHS3 and QLS3 may be turned on in complementary fashion, in order to illustrate the operation principle and process. Each operation cycle of the four-level converter can include six stages, and it is assumed that the capacity of flying capacitors CF1 and CF2 is large enough so that the voltages of flying capacitors CF1 and CF2 does not change significantly during the charging and discharging phase. When the duty cycle is less than ⅓, that is, output voltage VOUT is less than one third of input voltage VIN (VOUT<⅓VIN), the operation process is as follows.

In first stage t0-t1, transistor QHS3 can be turned on, transistor QHS2 turned off, transistor QHS1 turned off, flying capacitor CF2 can be charged, flying capacitor CF1 may be open circuited, and inductor current IL can rise. Balance switch S1 may be turned on, such that balance capacitor CBL1 can essentially be connected in series with flying capacitor CF2. Ignoring the on-resistance, the sum of voltage VCBL1 on balance capacitor CBL1 and voltage VCF2 on flying capacitor CF2 may be equal to input voltage VIN (VCBL+VCF1=VIN).

In second stage t1-t2, transistors QHS3, QHS2, and QHS1 can be turned off, the voltage of common node SW may be zero, flying capacitor CF2 can be open circuited, flying capacitor CF1 may be open circuited, and inductor current IL can decrease. Balance switches S1 and S2 can be turned off, and balance capacitors CBL1 and CBL2 may be open circuited. At this time, voltage VCF2 on flying capacitor CF2, voltage VCF1 on flying capacitor CF21, voltage VCBL1 on balance capacitor CBL1, and voltage VCBL2 on balance capacitor CBL2, may remain unchanged.

In third stage t2-t3, transistor QHS3 can be turned off, transistor QHS2 turned on, transistor QHS1 turned off, flying capacitor CF2 can be discharged, flying capacitor CF1 may be charged, and inductor current IL can rise. Balance switch S1 may be turned on, such that balance capacitor CBL1 can essentially be connected in series with flying capacitor CF1, and the series-connection of balance capacitor CBL1 and flying capacitor CF1 can be connected in parallel with flying capacitor CF2. At this time, the difference of voltage VCF2 and voltage VCF1 may be equal to voltage VCBL1 on balance capacitor CBL1 (VCF2−VCF1=VCBL1).

In fourth stage t3-t4, transistors QHS3, QHS2, and QHS1 can be turned off, the voltage of common node SW may be zero, flying capacitors CF2 and CF1 can be open circuited, and inductor current IL may decrease. Balance switches S1 and S2 may be turned off, and balance capacitors CBL1 and CBL2 can be open circuited. At this time, voltage VCF2 on flying capacitor CF2, voltage VCF1 on flying capacitor CF1, voltage VCBL1 on balance capacitor CBL1, and voltage VCBL2 on balance capacitor CBL2, may remain unchanged.

In fifth stage t4-t5, transistor QHS3 can be turned off, transistor QHS2 turned off, transistor QHS1 turned on, flying capacitor CF2 may be open circuited, flying capacitor CF1 can be discharged, and inductor current IL can rise. Balance switch S1 may be turned on, such that balance capacitor CBL1 can essentially be connected in parallel with flying capacitor CF1. At this time, voltage VCF1 on flying capacitor CF1 may be equal to voltage VCBL1 on balance capacitor CBL1 (VCF1=VCBL1).

In sixth stage t5-t6, transistors QHS3, QHS2, and QHS1 can be turned off, the voltage of common node SW may be zero, flying capacitors CF2 and CF1 can be open circuited, and inductor current IL may decrease. Balance switches S1 and S2 can be turned off, and balance capacitors CBL1 and CBL2 can be open circuited. At this time, voltage VCF2 on flying capacitor CF2, voltage VCF1 on flying capacitor CF1, voltage VCBL1 on balance capacitor CBL1, and voltage VCBL2 on balance capacitor CBL2, may remain unchanged. According to the above equation, VCF1=⅓VIN, and VCF2=⅔VIN. In summary, when duty cycle D is less than ⅓; that is, less than 1/M+1, balance capacitor CBL2 may not participate in the operation in an operation cycle. Therefore, balance circuit 52 may include only one balance sub-circuit in certain embodiments.

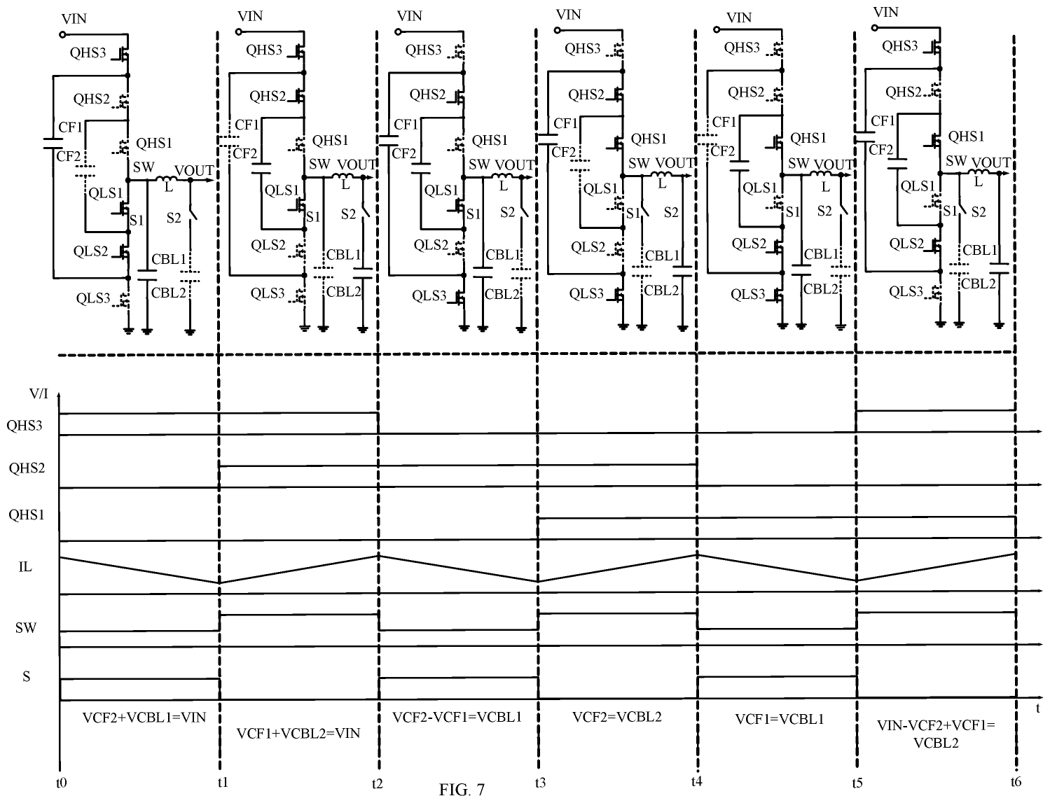

Referring now to FIG. 7, shown is a waveform diagram of a second example operation of the second three-level converter, in accordance with embodiments of the present invention. When the duty cycle is not less than ⅓ and not greater than ⅔; that is, output voltage VOUT is not less than one third of input voltage VIN and is not greater than two thirds of input voltage VIN (⅔VIN>VOUT≥⅓VIN), the operation process can be as follows. In first stage t0-t1, transistor QHS3 may be turned on, transistor QHS2 turned off, transistor QHS1 turned off, flying capacitor CF2 can be charged, flying capacitor CF1 may be open circuited, and inductor current IL may decrease. Balance switch S1 can be turned on, and balance switch S2 turned off, such that balance capacitor CBL1 may essentially be connected in series with flying capacitor CF2. At this time, the sum of voltage VCBL1 on balance capacitor CBL1 and voltage VCF1 on flying capacitor CF1, may be equal to input voltage VIN (VCBL1+VCF1=VIN).

In second stage t1-t2, transistor QHS3 can be turned on, transistor QHS2 turned on, transistor QHS1 turned off, flying capacitor CF2 may be open circuited, flying capacitor CF1 can be charged, and inductor current IL may rise. Balance switch S2 can be turned on, and balance switch S1 turned off, such that balance capacitor CBL2 may essentially be connected in series with flying capacitor CF1. At this time, the sum of voltage VCBL2 on balance capacitor CBL2 and voltage VCF1 on flying capacitor CF1 may be equal to input voltage VIN (VIN=VCF1+VCBL2).

In third stage t2-t3, transistor QHS3 can be turned off, transistor QHS2 turned on, transistor QHS1 turned off, flying capacitor CF2 may be discharged, flying capacitor CF1 can be charged, and inductor current IL can decrease. Balance switch S1 may be turned on and balance switch S2 is turned off, such that balance capacitor CBL1 may essentially be connected in series with flying capacitor CF1 and then in parallel with flying capacitor CF2. At this time, the difference of voltage VCF2 and voltage VCF1 can be equal to voltage VCBL1 on balance capacitor CBL1 (VCF2−VCF1=VCBL1).

In fourth stage t3-t4, transistor QHS3 can be turned off, transistor QHS2 turned on, transistor QHS1 turned on, flying capacitor CF2 discharged, flying capacitor CF1 may be open circuited, and inductor current IL can rise. Balance switch S2 can be turned on, and balance switch S1 may be turned off, such that balance capacitor CBL2 can essentially be connected in parallel with flying capacitor CF2. At this time, voltage VCF2 on flying capacitor CF2 may be equal to voltage VCBL2 on balance capacitor CBL2 (VCF2=VCBL2).

In the stage t4-t5, transistor QHS3 turned off, transistor QHS2 turned off, transistor QHS1 turned on, flying capacitor CF2 may be open circuited, flying capacitor CF1 can be discharged, and inductor current IL may decrease. Balance switch S1 can be turned on, and balance switch S2 turned off, such that balance capacitor CBL1 may essentially be connected in parallel with flying capacitor CF1. At this time, voltage VCF1 on flying capacitor CF1 may be equal to voltage VCBL1 on balance capacitor CBL1 (VCF1=VCBL1).

In sixth stage t5-t6, transistor QHS3 can be turned on, transistor QHS2 turned off, transistor QHS1 turned on, flying capacitor CF2 can be charged, flying capacitor CF1 may be discharged, and inductor current IL can rise. Balance switch S2 may be turned on, and balance switch S1 turned off, such that flying capacitor CF1 can essentially be connected in series with flying capacitor CF2. Also, the series-connection of flying capacitor CF2 and flying capacitor CF1 can be connected in parallel with balance capacitor CBL2, and balance capacitor CBL1 can be open circuited. At this time, the sum of voltage VCF2 on flying capacitor CF2 and voltage VCF1 on flying capacitor CF1 is equal to voltage VCBL2 on balance capacitor CBL2 (VCF2+VCF1=VCBL2), and voltage VCBL1 on balance capacitor CBL1 may remain unchanged.

From the analysis of the above working process, no matter what a range of duty cycle D is in, the capacitance-voltage relationship in the first, second, third, fourth, fifth, and sixth stages may satisfy Formulas (1)-(6) shown below.

$$VIN = VCBL 1 + VCF 2 \qquad ( 1 )$$

$$VIN = VCBL 2 + VCF 1 \qquad ( 2 )$$

$$VCF 2 - VCF 1 = VCBL 1 \qquad ( 3 )$$

$$VCF 2 = VCBL 2 \qquad ( 4 )$$

$$VCF 1 = VCBL 1 \qquad ( 5 )$$

$$VIN - VCF 2 + VCF 1 = VCBL 2 \qquad ( 6 )$$

Combining the above six equations, we can get Formula (7) shown below.

$$VIN = 3 / 2 VCF 2 = 3 / 2 VCBL 2 = 3 VCF 1 = 3 VCBL 1 \qquad ( 7 )$$

In addition, when duty cycle D is greater than ⅔ (D>⅔), the capacitance-voltage relationship in the first, second, third, fourth, fifth, and sixth stages may also satisfy the above voltage relationship, such that the voltage of the flying capacitor can be balanced. However, when duty cycle D is greater than ⅔ (D>⅔), transistors QHS3, QHS2, and QHS1 can be turned on in the first, third, and fifth stages, and in these stages balance capacitor CBL1 can be disconnected from common node SW. Therefore, in the operation cycle, only in the second, fourth, and sixth stages, may balance capacitor CBL2 connect to common node SW. Therefore, when duty cycle D is greater than ⅔, that is, greater than M/M+1, balance capacitor CBL1 may not participate in the operation in one operation cycle. Balance circuit 52 can also include only one balance sub-circuit in certain embodiments. It can be seen that the four-level converter of particular embodiments may realize the voltage balance of the flying capacitor, the voltage on the flying capacitor can remain at a target voltage, and the target voltage may be ⅓VIN or ⅔VIN.

The example four-level converter can utilize balance circuit 52, in order to control the flying capacitor and the balance capacitor to be selectively connected in series or in parallel by controlling he balance switch to be selectively turned on and off. In this way, in different operation stages of an operation cycle, a proportional relationship between the voltage on the balance capacitor and the voltage on the flying capacitor can be generated, and a proportional relationship between the voltage on the balance capacitor, the voltage on the flying capacitor, and input voltage VIN or output voltage VOUT, may be generated. Thus, balance control of the flying capacitor can be realized, as well as multi-level converter lossless balance. As compared with the traditional balance approach, this method may have advantages of relatively simple control, high balance accuracy, good robustness, and wide adaptability.

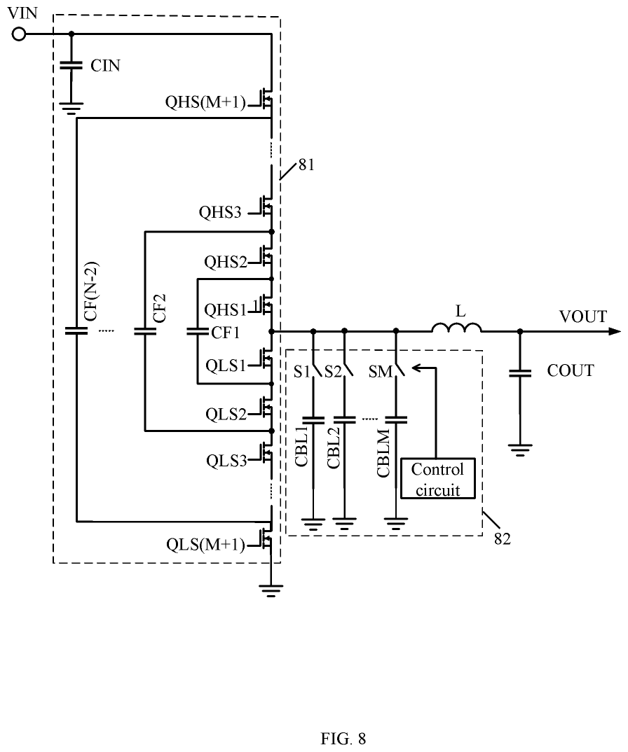

Referring now to FIG. 8, shown is a schematic block diagram of a third example multi-level converter, in accordance with embodiments of the present invention. This particular example multi-level converter (e.g., N-level converter) can include switch capacitor circuit 81, balance circuit 82 and inductive element L. Switch capacitor circuit 81 can include M flying capacitors and 2*(M+1) transistors, where M is a positive integer and M+2=N. Also, 2*(M+1) transistors can connect in series between input voltage VIN and the ground terminal of the N-level converter. One terminal of transistor QHSn can connect to one terminal of transistor QLSn through flying capacitor CFn. Switch capacitor circuit 81 can also include filter capacitor CIN. Filter capacitor CIN can connect to the input terminal of the N-level converter. For example, N is a positive integer, greater than or equal to 1, and less than or equal to M.

Balance circuit 82 can realize the balance control of the flying capacitor by changing the series-parallel relationship between the flying capacitor and the balance capacitor in the balance circuit in different operation stages of an operation cycle. Balance circuit 82 can connect between common node SW and the ground terminal. Also, (M+1) transistors connected in series between the input terminal of the multi-level converter and common node SW can be configured as upper transistors, where the upper transistors include transistors QHS (M+1), . . . , QHS3, QHS2 and QHS1. Also, (M+1) transistors connected in series between common node SW and the ground terminal configured as lower transistors, where the lower transistors include transistors QLSM+1, . . . , QLS3, QLS2, and QLS1.

In particular embodiments, balance circuit 82 can include M balance sub-circuits, where each balance sub-circuit can include a balance switch and a balance capacitor connected in series. When the n-th balance sub-circuit is involved in the operation, balance switch Sn in the n-th balance switch can be turned on, and balance capacitor CBLn can be coupled with at least one flying capacitor, and only one balance switch in the balance sub-circuit may be turned on during the same period. When the voltage of common node SW is equal to input voltage VIN or zero, all the balance switches can be turned off, and balance circuit 82 may essentially be disconnected from common node SW. That is, when (M+1) upper transistors are turned on, or no upper transistor is turned on, all the balance switches in balance circuit 82 can be turned off, and balance circuit 82 may be disconnected from common node SW.

Furthermore, the steady voltages of the balance capacitors in the M balance sub-circuits can be different, and the voltage difference between the balance capacitors in the two adjacent balance sub-circuits may be VIN/(M+1) or VOUT/(M+1), where VIN and VOUT are the input voltage and output voltage of the multilevel converter, respectively. In this example, the N-level converter is a buck topology, and the steady voltage difference between the balance capacitors in the two adjacent balance sub-circuits is VIN/(M+1). In other examples, when the N-level converter is a boost topology, the steady voltage difference between the balance capacitors in the two adjacent balance sub-circuits can be VOUT/(M+1). Here, the steady voltage may refer to the average voltage of the capacitor after the multi-level converter has started and finally stabilized under the condition that the input voltage and load remain unchanged. In particular embodiments, the steady voltages of balance capacitors CBL1, CBL2, CBL3, . . . , CBLM are VIN/(M+1), 2*VIN/(M+1), 3*VIN/(M+1), . . . , M*VIN/(M+1), respectively.

When the voltage of common node SW is n*VIN/(M+1) or when n upper transistors are turned on, balance switch CBLn in the n-th balance sub-circuit can be turned on to couple balance capacitor CBLn with at least one flying capacitor through common node SW, where n=1, 2, . . . , M. Similar to the operating principle of the above three-level converter and four-level converter, the N-level converter of particular embodiments can also realize the voltage balance of the flying capacitor, and a target voltage can be maintained.

The N-level converter can control the flying capacitor and the balance capacitor to be selectively connected in series or in parallel by controlling he balance switch to be selectively turned on and off. In this way, in different operation stages of an operation cycle, a proportional relationship between the voltage on the balance capacitor and the voltage on the flying capacitor is generated, and a proportional relationship between the voltage on the balance capacitor, the voltage on the flying capacitor, and input voltage VIN or output voltage VOUT, can be generated. Thus, balance control of the flying capacitor is realized, as well as multi-level converter lossless balance. As compared with the traditional balance approach, this method may have advantages of relatively simple control, high balance accuracy, good robustness, and wide adaptability.

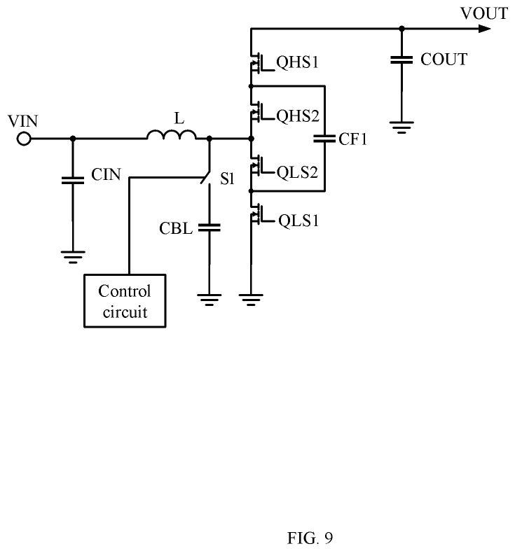

Referring now to FIG. 9, shown is a schematic block diagram of a fourth example multi-level converter, in accordance with embodiments of the present invention. As compared with the first example multi-level converter, the three-level converter here is a three-level boost converter, and other circuit structures and operating principles are similar to those described above. This example multi-level converter can include a switch capacitor circuit, a balance circuit, and inductive element L.

The embodiments were chosen and described in order to best explain the principles of the invention and its practical applications, to thereby enable others skilled in the art to best utilize the invention and various embodiments with modifications as are suited to particular use(s) contemplated. It is intended that the scope of the invention be defined by the claims appended hereto and their equivalents.

What is claimed is:

1. A multi-level converter, comprising:
a) a switch capacitor circuit having M flying capacitors and 2*(M+1) transistors, wherein M is a positive integer;
b) an inductive element;
c) a balance circuit coupled to a common node of the switch capacitor circuit and the inductive element; and
d) wherein the balance sub-circuit comprises at least one balance sub-circuit, a balance switch, and a balance capacitor, and wherein the flying capacitor and the balance capacitor are coupled to each other in one of series and parallel connections by controlling the balance switch to selectively to be turned on and off.

2. The multi-level converter of claim 1, wherein the balance circuit is configured to control a proportional relationship between a voltage on the balance capacitor and a voltage on the flying capacitor, and a proportional relationship between the voltage on the balance capacitor, the voltage on the flying capacitor, and an input voltage or an output voltage of the multi-level converter, in different operating stages of an operating cycle.

3. The multi-level converter of claim 1, wherein the balance circuit is coupled between a common node and a ground terminal, wherein the (M+1) transistors coupled sequentially in series between the input voltage or the output voltage and the common node are configured as upper transistors, and wherein the (M+1) transistors coupled sequentially in series between the common node and the ground terminal are configured as lower transistors.

4. The multi-level converter of claim 3, wherein when a voltage at the common node is equal to one of the input voltage and a zero voltage, the balance circuit is disconnected from the common node.

5. The multi-level converter of claim 3, wherein when the (M+1) upper transistors are turned on, or when none of the upper transistors are turned on, the balance circuit is disconnected from the common node.

6. The multi-level converter of claim 3, wherein the balance circuit comprises M balance sub-circuits, and each balance sub-circuit comprises a balance switch and a balance capacitor connected in series.

7. The multi-level converter of claim 6, wherein when the balance switch is turned on, the balance capacitor is coupled to at least one of the flying capacitors, and only one balance switch in the balance sub-circuit is turned on at the same time period.

8. The multi-level converter of claim 6, wherein:
a) steady voltages of the balance capacitors in the M balance sub-circuits are different;
b) a steady voltage difference between the balance capacitors in two adjacent sub-circuits is VIN/(M+1) or VOUT/(M+1); and
c) VIN and VOUT are the input voltage and the output voltage of the multilevel converter, respectively.

9. The multi-level converter of claim 8, wherein:
a) when the voltage at the common node is n*VIN/(M+1) or n*VOUT/(M+1), the balance switch in the n-th balance sub-circuit is turned on; and
b) n is a positive integer not greater than M, and the steady voltage of the balance capacitor in the first balance sub-circuit is VIN/(M+1) or VOUT/(M+1).

10. The multi-level converter of claim 9, wherein when n upper transistors are turned on, the balance switch in the n-th balance sub-circuit is turned on, and the steady voltage of the balance capacitor in the first balance sub-circuit is VIN/(M+1) or VOUT/(M+1).

11. The multi-level converter of claim 6, wherein the balance switch is configured as a bidirectional current blocking transistor.

12. The multi-level converter of claim 6, wherein the balance circuit comprises a control circuit that is configured to control a corresponding balance switch in the balance sub-circuit to be turned on when a voltage at the common node is not either of the input voltage and a zero voltage.

13. The multi-level converter of claim 1, wherein when a duty cycle of the switch capacitor circuit is less than 1/M+1 or greater than M/M+1, the balance circuit comprises only one balance sub-circuit, and the balance sub-circuit comprises a balance switch and a balance capacitor coupled in series.

14. The multi-level converter of claim 1, wherein the balance circuit is configured to control the balance switch to be turned on and turned off based on a voltage on the common node of the switch capacitor circuit and the inductive element.
